(19) United States
(12) Patent Application Publication
(10) Pub. No.: US 2014/0280492 A1
(43) Pub. Date: Sep. 18, 2014

(54) Method and System for Distributing Data among a Multi-Tenant service with a Shared Userbase

(71) Applicants: Grant Chieh-Hsiang Yang, Fairview, TX (US); Jason Yang, Sunnyvale, CA (US)

(72) Inventors: Grant Chieh-Hsiang Yang, Fairview, TX (US); Jason Yang, Sunnyvale, CA (US)

(21) Appl. No.: 13/844,616

(22) Filed: Mar. 15, 2013

(51) Int. Cl. G06F 15/173

(52) U.S. Cl. CPC G06F 15/17306
USPC 709/203

(57) ABSTRACT

A method and system for distributing data among a multi-tenant system with shared and non-shared users. Shared users may be global across the system or per tenant or developer. Non-shared users would be per app. While some data would be shared across users, other data stored within the multi-tenant system would be related specifically to the app, including gameplay data and non-gameplay data, such as leaderboards, inventory, virtual currency. Userbases may be upgraded and downgraded per app or per developer.

There are many types of applications and genres available on computing devices. There are games, news, entertainment, etc. Some of these application can be standalone on a client (e.g. smartphone, PC, etc.) without a network connection; however, others require a network connection, which may not have to always be active to use all the features of the application, but may in-part be to share features or data.

Client developers (i.e. developers that develop applications that the user interfaces with) frequently deal with certain skill sets and language sets. For example, cross-platform “engines” are typically written in C or C++ and engines may allow client developers to write to the engine in a single language, such as C# or Javascript, and many engines have their own scripting language. On the other hand, many common server or “backend” languages or technology are written in PHP, Python, Ruby and database languages such as MySQL. These languages, technologies, and architectures require a different skill set between client and server developers often lead to developers specializing in one or the other. Of course, for certain technologies, there may be some overlap. For example, low-level server code may be written in C++, or likewise, Javascript may be used in both “frontend” client applications as well as being for backend development. This overlap largely also depends on the type of application that is being created as well as the infrastructure, scalability, and data structures needed on the backend.

Even on the client side, for certain types of applications, such as games, there are various different types of languages that may be used for “game engines,” wherein a client developer can write one language and the game engine exports to various other platforms, operating systems, etc. This would be for the purpose if a client developer wanted to develop an application or game that can be deployed cross-platform immediately. On the backend, however, a client engineer would need to ask a server engineer to create the API (Application Programming Interface) calls necessary to create specific functionality. Another separate developer may call upon another server engineer to create similar calls, particularly those involving games. The divergent skill sets of client and server, in addition to the cost and time needed to concurrently build the features for a backend solution while the client (frontend) is being built, presents a challenge for application development.

### BRIEF DESCRIPTION OF THE DRAWINGS

FIG. 1a illustrates a schematic of an example configuration of a multi-tenant system with a shared userbase.

FIG. 1b illustrates a schematic of an example configuration of a multi-tenant system with a shared userbase and specific various features of the multi-tenant system.

FIG. 1c illustrates an example embodiment of a computing system architecture which may be used to implement any number of computing devices, whether server, client, smartphone, etc.

FIG. 2a illustrates an example of a schematic structure of a multi-tenant backend system with a shared userbase with both shared and non-shared users as well as various developers as tenants.

FIG. 2b illustrates an example of a data structure relationship of a multi-tenant backend system with a shared userbase with both shared and non-shared users.

FIG. 3a depicts an example process flow of how a multi-tenant system with shared users and non-shared users may receive and process data from a client.

FIG. 3b depicts an example process flow of how a multi-tenant system with shared users and non-shared users may receive and process non-user data from a client.

FIG. 3c illustrates an example process flow of how a multi-tenant system with shared users and non-shared users where applications or developers may enter the multi-tenant system and user data may be merged or de-coupled.

### DETAILED DESCRIPTION

Due to the divergence in skill sets, some client engineers or developers may prefer to use a service that implements backend pre-written backend behavior through an API (Application Programming Interface) Like a frontend “game engine”, a client developer may find value if an “engine” for the backend had known features that were re-usable to that client developer across applications that the client developer intended to create. For example, there are various types of applications, such as news applications that may have similar features. News features may need to be able to get new headlines, new documents, user logins, etc. In games, there may be features such as achievements or quests, leaderboards, virtual currency, inventory management, etc. In example embodiments of the present invention, a client developer may want to access specific solutions to a game through an API. Such developers may also be able to access these backend routines, data structures, algorithms, etc. through an SDK (Software Development Kit) or any other type of wrapper for any communication protocol with a server technology accessible from the client device.

After the development of an application is completed, a large role in the success of the application is the method of distribution and marketing. Typically, user acquisition is a difficult problem, particularly for “social” applications, such as those distributed on smartphones or on a social network platform. Part of the reason for this issue is because players typically do not like to have to sign up for multiple accounts on different applications. Players may want to do this because attention span is low and retention on applications (or “apps”) does not warrant having to create and remember a username, password, or other account information. Players may also be reluctant to create an account because of the growing fears of user privacy on networks, as well as the risks of the personal data being stolen or even sold by those networks. However, even if multiple developers decided they wanted to team up, it would be difficult to share their userbase without sharing account information and other critical data that developers may not want to share across apps.

When applications are developed, there are typically features that may require a backend implementation, either to store data, receive data and transform and manipulate the data and return it to a user, or manipulate the data and return it to a different user that is using that application. However, applications, particularly social applications, such as game applications, require both a backend implementation as well as a social discovery network. However, in order for the integration of the two concepts, there must be a method of determining which data may be applied to users when they are shared across applications and developers, and when data is to be sequestered and not accessible by other applications.

Example embodiments of the present invention may include implementations of a method and system for distributing data among a multi-tenant system with a shared userbase. The system may silo information specific by any number of variables to determine a unique location, variables such as a developer, an app made by the developer, and user specific to the app, or a user specific to the developer, or a user shared across the multi-tenant system.

A method for distributing data among a multi-tenant service may contain a shared userbase, comprising receiving a first request to process a first data packet of data, receiving a first key associated with the first data packet and a first application, receiving a second key associated with the first data packet, storing the data packet in a first storage location, receiving a second request to obtain the data packet from the first storage location, and transmitting the first data packet in response to the second request. The method's operations are executed by one or more processors. The second key may be associated with a first user. The method may further comprise determining the first storage location within a first data module for the first data packet based on at least one of the first key, the second key, and a user data type for the first data packet, wherein user data type is one of shared or non-shared. The first data packet may be one of gameplay or non-gameplay data. The first data packet may comprise at least one of leaderboard ranking, leaderboard score, leaderboard rating, non-leaderboard related skill rating, achievement, state data, gameplay data, virtual currency balance, inventory balance, and avatar selection. The method for distributing data may further comprise receiving business logic instructions and executing the business logic instructions on the first data packet. The method may also comprise sending the first data packet to be processed; and receiving the processed first data packet and further storing the first data packet. The method and system may further comprise triggering the transmission of a network call to a third party. The third party may be a push notification server and the user notified is shared on the multi-tenant system. An apparatus, comprising one or more processors; and a memory coupled to the processors comprising instructions executable by the processors, the processors operable when executing the instructions may perform any of the above method or system. Likewise, a non-transitory, computer readable medium comprising instructions operative, when executed, cause one or more processors to perform operations comprising any of the above method or system.

Detailed descriptions of the above example embodiments may be illustrated herein.

FIG. 1a illustrates a schematic of an example configuration of a multi-tenant system with a shared userbase. The schematic depicts the data flow between the components of the system. Humans 1000 and 1001 (who may be users, players, etc.) may access client terminals 1002, which may be a larger client device with processors like a desktop 1003 or laptop 1004 or may be a handheld device, such as a smartphone 1005, feature phone 1006, or any other number of client computing devices, such as a tablet, PDA, etc. that are not depicted. It is noted that the system is not limited to only two users, and there may be multiple client terminal 1002 configurations per user. The client terminals 1002 may be an interface such as a web application or a stand-alone application on a smartphone or other client in any number of formats. The client terminals 1002 may interact through a communication link 1007 to a network 1008. The communication link 1007 may communicate over a network through any number of networks 1008, such as through servers or proxy servers, through the internet, through portions of a network, through an ad hoc network, an intranet or extranet, through firewalls, over a virtual private network (VPN), local area network (LAN), wireless LAN (WLAN), wide area network (WAN), wireless WAN (WWAN), through public or private networks, and the communication link may be over number of fiber, cable, satellite, DSL, wireless or other form of technology or communication, or a combination thereof.

The network 1008 may in turn communicate with an application module 1009 which may contain the various features, logic, algorithms that process data incoming from the client terminals or devices 1002. The databases of the modules may also store information and be able to retrieve the information and to send to different client terminals 1002 of the users 1000 & 1001. In addition, the user module 1010 may also be altered by information coming from the client terminals 1002, or data may be retrieved and sent from either module 1009 or 1010 to the client terminals 1002.

In alternative instances of the system, anything that is completed over a network may be configured to be completed on the client, on the server, on a combination of both, or executed exclusively on one device and have the information passed and parsed on another device. Moreover, in all instances of the system, any storage of information that is sent from a client may be processed and stored in a single module on a single database, or may be distributed across multiple servers. Moreover, the clients or servers or other computing devices may be arranged in any number of methods, including different types of mass storage, processors, cache, etc. The processing units may be any variation of processing technology, including but not limited to, central processing units (CPUs), graphic processing units (GPUs), etc. or other processing modules. The input/output (i/o) method may be across a high performance bus or any combination of i/o technologies and the client and server devices may run on any single or combination of operating systems, including but not limited to the Windows, LINUX, unix, Apple Macintosh, etc. The storage elements may be consist of any type of non-transitory storage media, including but not limited to, tapes, disks, dynamic random-access memory (DRAM), optical disc drives, volatile memory that may be later transferred to non-volatile memory components, optical memory storage, flash memory, etc. and in any type of configuration, such a single storage devices, redundant array of independent disks (RAID) configurations, cloud storage, etc. Moreover, the information may be processed on any type of server, regardless of the designated name (i.e. a “game” server may process game moves but may also process economy or purchase function calls or analytics calls, and vice versa).

FIG. 1b illustrates a schematic of an example configuration of a multi-tenant system with a shared userbase and specific various features of the multi-tenant system. As in the previous example, there may be one or more users (not shown for purposes of this example) that are using apps on devices 1100 and 1101. From the first example client device 1100, data may be transported via communication links 1102 to the network that passes it to a computing device that processes the API requests 1103. The client devices 1100 and 1101 may access applications that are developed by a single tenant (i.e. developer, group of developers, contractor working for one or more other developers, or any combination thereof); or one or more devices may access multiple applications developed by multiple tenants in the multi-tenant system. The client devices 1100 and 1101 may also be cross-platform, meaning across operating systems.

Processing may occur on any number of cloud, distributed computing, or other computing or storage combination therein. The API processing 1103 may need to access other third party API's or cloud networks, such as those for Social Networks 1104, over a communication link 1105 in order to obtain a user's information that is separately stored at the third party. Other third party services may be communicated with over a communication link 1106, such as an In-App-Purchase (IAP) service 1107 for the purpose of purchases virtual or in-app items in exchange for real-world currency. The IAP service may be associated with a specific OS (e.g. Apple), social network (e.g. Facebook), or manufacturer (e.g. Samsung). The IAP module may be within that of a third party, though there may be IAP modules part of the multi-tenant system. A communication link 1109 may also access an application module 1108 which may control the logic and processing for the receipt of information from the social network 1104 processing, IAP 1107 processing and push notification module 1110.

A push notification module 1110 may be implemented within the multi-tenant system that can send push notifications to devices 1100 and 1101. In other examples, a push notification module 1110 may be handled through a third party system. The push notification module may send push notifications to devices 1100 and 1101 as administered through push notification settings 1111 that may send to a subset of users, based on a number of variables, such as time, time zone, device type, Operating System (OS) type, message type, etc. Alternatively, push notifications may be sent directly from one device 1100 to another device 1101 through the push notification module 1110 as a simple intermediary. The push notification settings 1111 may be altered dynamically by an administrator, through an administrator portal 1112 on any type of client device, via a communication link 1113 between the administrator and the push notification settings 1111 via the push notification module 1110. The push notification module 1110 may also interact with the user module 1115 through the various API processing cloud 1103 and the user module 1115 via the communication links 1113-4. The user module 1115 may further contain settings that override or possibly supplement the push notification settings 1111. For example, a specific user may be set to choose not to receive any push notifications, and may therefore override any pushes sent out globally to all users. Alternatively, a global push may be sent out for global users at their “lunch hour”, but the information for time zone to determine this may be stored with the user in the user module 1115.

One of the advantages of an example embodiment of the multi-tenant system is that rather than having a significant amount of interaction or instructions coming from the client, the networking processes and communication may be done on the server. Concentrating the networking instructions, processing, communication or redirection may be advantageous because networking calls on the client are generally more costly on the client than the server. The “cost” may be monetary cost as client devices in many countries are charged for a data plan; thus, the fewer calls that a client device would make would be advantageous for a developer's customers. In addition, networking frequently drains battery life of the client device more than other types of processing. Therefore, if the same information may be used by the server to process multiple calls, then it would be advantageous to have the server process this information.

For example, in one possible use case a developer may have an app hosted on the multi-tenant system that is an asynchronous player-versus-player (PvP) game. When a first player makes a move in the asynchronous game, not only is the data stored as a move in the match, but the opponent is notified that the first player has made a move and that it is the opponent's turn. Where a client developer's asynchronous game is not part of a multi-tenant system that is cross-platform, the client developer would have to make a network request to a server to store the move data, then make a request to the push notification service on its own platform to send a request to the opponent, and if the opponent is known to be playing across multiple platforms, make another networking request to an intermediary push notification service that can potentially connect to the push notification service of another platform to send a push notification to the opponent device. However, if a client developer were on a multi-tenant system, such as the one described in this application, that can process and store gameplay elements and provide them, through a network, to client devices cross-platform, then there may be cost savings for the client developer and the developer's users. For example, the same gameplay move may be made in the asynchronous game. However, because the move is made on the multi-tenant system, the system handles not only the storing of the request, but also would trigger a push notification to be made to all the devices of the opponent that are registered on the system, regardless of the platform they are on. Thus, the client device in the multi-tenant system would have made only one network request rather than multiple calls to address the same issue.

The Administrator Portal 1112 may be used to alter various aspects of the other modules, as will be explained later. Through the Administrator Portal 1112, an administrator may alter users and their features in the user module 1115, such as any relation between a user and his or her social network connections. The Administrator Portal 1112 may also be able to alter the IAP of a user, whether for applications or overall in the system. This may be done directly through server receipts with the IAP 1117 cloud or via the user module 1115. For example, an administrator may be able to find a user and alter a user's purchases, whether through direct IAP or through purchases via virtual currency that were earned or alternatively purchased through IAP. The administrator portal 1112 may be used to send push notifications by changing the push notification settings 1111 to send push notifications via the push notification module 1110. The administrator portal 1112 may also be used to add third party logic or access third party services.

A tenant may decide to work with other Third Party Services 1121 that may be accessible directly or through various other third party cloud services that provide processing 1119. A Third Party Logic Module 1117 may store the specific custom logic that is not specifically provided through the API Processing 1103 of the API Processing Module (which may be integrated in the cloud shown in API Processing 1103 or in a separate module). Communication between these various modules may occur through communication links 1116, 1118, and 1120. The Third Party Logic Module 1117 may be stored and processed in the third party service, stored on the multi-tenant system but provided by a tenant, or stored on a tenant's own servers. Third Party Logic may include processing of data within the applications for features such as ads, analytics, etc. Some of this third-party logic module may easily be brought within the multi-tenant system or the processing may even be shared across both the Application Module 1108 and the third party logic module 1117.

For example, the Application Module 1108 may have a feature set to serve ads to the client devices 1100 and 1101. The scheduling of when the client devices 1100 and 1101 may receive ads or the type of ad may be determined by the Application Module 1108. On the other hand, the actual ads available and the revenue earned by the particular application serving the ad to the client may be determined by the third party ad network. The Application Module 1108 may also cache some of the ads in order to maximize the type of ads served as well as the type of ad (e.g. banner, full-screen interstitial ad, video ad, etc.). The Application Module 1108 may also track which ads have been sent to which individual users so that individual users are not bombarded with the same ad, thus reducing the ad's efficacy and revenue potential. On the other hand, the Third Party Logic Module 1108 which is accessing the Third Party Service, in this example the ad network, may also contribute by requesting ads from the one or more ad networks in order to have more ads in the rotation for the Application Module 1108 to obtain variety of ad type, ad message, and ad revenue. If the Application Module 1108 had specific user information (e.g. age, sex, physical location, etc.), ads from the ad networks may be targeted to increase the likelihood of user response so the ad and also decrease the aggravation to the user if the ad were relevant to the user.

Another example of a third party service may be an analytics service that is used by any of the applications on the multi-tenant system. The application module 1108 itself may fully perform the analytics tracking, but it may also share some of this processing and storage responsibility with a third party service. One example of how the multi-tenant system may share the analytics duties is for the multi-tenant system to only track aggregate level data while the third party service 1121 tracks user-level data. For example, the multi-tenant system may on the aggregate track the total number of users that have used an application each day, otherwise known as an application's DAU (daily active user). However, a third party service may track each individual user that has used an application each day. Therefore, if an application developer needed to track the actual days a particular user used the application, he would be able to retrieve this information from the third party service. Having this data mirrored may be beneficial because the individual and aggregate data may verify the numbers of the two services. Moreover, if a client device need only make a single network call and the data is tracked in multiple ways on multiple services, not only is there a redundancy on saving the data but the client device does not need to waste resources sending multiple network calls to multiple different third party services. Quite often, third party services require client devices to install an SDK, and this may be costly in development time because the SDK may not be written in the language or for the platform of the client developer's application. Precious development time may be spent porting the SDK into the proper format. In addition, if a client device had to make a network call for each third party SDK, the networking bandwidth may be costly for the client device. Therefore, having the multi-tenant device manage the network traffic for all the third party analytics is advantageous because then only the multi-tenant's SDK needs to send the information.

Applications in the multi-tenant system may be asynchronous, i.e. individual calls to alter data in the system or provide new or updated data to the system, and they may also be synchronous, i.e. real-time changes. In one example embodiment, the API Processing 1103 and the Application Module 1108 may hand of information depending on what is needed to prevent latency and to store information. For example, in a synchronous game driving game, there may be a TCP/IP (transmission control protocol/internet protocol) connection providing end-to-end connectivity between the devices or hosted on an intermediary server. In this way, the latency between the devices may be minimized as more processing is done on the clients, or that it appears to be in real-time. However, certain pieces of information may still need to be stored or processed. For example, as a player is in the driving game, he may decide to purchase a powerup or purchase a modification to the car. An asynchronous networking call may need to be made to determine whether the player has enough virtual currency. Alternatively, data may be temporarily stored or cached on a server or possibly on the client, and after a “race” is completed in the driving game or the real-time connection is ended, the results may be uploaded to the server. Continuing with the example, a client device may have a temporary mirrored data of the virtual currency; therefore, a separate call to an asynchronous server is not needed to disrupt the real-time flow of the driving game. After the real-time information is completed, the changed items on the client may be synchronized with the multi-tenant system. The post-synchronous updates also allow players to continue to use their accounts, particularly global shared user accounts, cross-platform easily. For example, if a player is on one type of device or operating system, such as a Microsoft Xbox or an Apple iPhone, and then wanted to play instead of a different platform, such as a Sony Playstation or a Google Android phone, the data would be synchronized across the platforms. In either the synchronous or asynchronous example, the data that is affected in the multi-tenant system may be gameplay elements or non-gameplay elements. Gameplay elements may include, for example, elements that are actually used in the process of playing the game, such as inventory (e.g. vehicles, guns, avatars, etc.) or powerups (i.e. boosts, extra life, etc.). Whereas non-gameplay elements may include the superfluous elements that are not necessarily needed to play the game, such as leaderboards, achievements, matching players, friend lists, etc.

A leaderboard may be a ranking system wherein users are ranked by a pre-determined metric of the game. For example, a “high score” may be a method of ranking players. Another method may be a user's win/loss record, or simply a win record. Achievements are usually found in games, sometimes referred to as quests or badges, where a user performs a certain activity and then receives acknowledgment that they have finished the activity or groups of actions.

Variations of the different combinations of the data flow will be explained in later figures. There may be reasons why a user would want to go through a server versus only sending through client. Data may be stored as part of the multi-tenant system, may be stored where information is processed, but may also be stored separately or duplicated in order to ensure reliability and performance.

FIG. 1c illustrates an example embodiment of a computing system architecture which may be used to implement any number of computing devices, whether server, client, smartphone, etc. In the architecture, the buses 1200 and 1209 may enable the communication between different parts of the hardware architecture. Some computing architectures may contain one or more bus bridges 1210, which may consist of chipsets that coordinate traffic among the busses. The embodiment in this example may contain various items on one bus or another, but other alternative architectures may contain different elements on the separate busses, or, all elements on the same bus, whether physically or virtually. The bus 1200 may connect to I/O ports 1202 and connect to various hardware devices, such as a mouse 1203, keyboard 1204, or monitor 1205. The computing system may also contain a peripheral component interconnect (PCI), which may take the form of an integrated circuit or an expansion card. The example PCI 1206 may connect via a local bus. The example PCI hardware may include network cards, modems or other network cards, disk controllers, etc. The example computing system may also contain a central processing unit 1207, which may be a single chip or multi-core processor and may contain components such as an arithmetic logic unit (ALU) and a control unit (CU). A cache 1212, or any other fast memory module, may be tied to the CPU.

The bus 1200 may also connect to storage 1201. The storage may come in various forms and in various speeds and sizes. For example, there may be disk storage recorded by various electrical, magnetic, optical, or mechanical methods. Examples of disk storage would be a hard drive, zip drive, minidisc, laser disc, digital versatile disc (DVD), compact disc (CD), blu-ray disc, floppy disc, etc. Each of these methods of storage may have different rotational rates, seek times, data transfer rates, power consumption, shock or other damage resistance, file system type, etc. The decision to choose a storage may depend on any number of factors, such as storage size, latency, cost per storage size, redundancy, etc. For example, in the area of redundancy, some storage may be in the form of a RAID (redundant array of independent disks) setup, wherein multiple disk drive components are formed to serve as a single logical unit. Moreover, within the RAIDs there may be multiple different types of schemes to divide or replicate data, and this may be performed through storage virtualization. There may be various types of methodologies used such as data striping, to segment logically sequential data so that consecutive segments are stored on different physical storage elements. Another methodology is parity, which may be used to verify certain groups of data. Another methodology may disk or data mirroring or alternatively file shadowing, or any other methods of replication of data or redundancy of data with varying degrees on the effect of read or write speed of that data. Other forms of storage may be used, such as solid-state drives (SSD), such as flash memory. And connections of storage may be directly in the bus or connected externally through any type of interface to the bus, such as Serial ATA (SATA), parallel ATA, etc.

The computing architecture may contain other components such as a GPU 1211 (graphical processing unit), RAM (random access memory) 1208, networking 1213 modules or components, or a ROM BIOS 1214 (read only memory basic input output system). The computing architecture may combine various elements of the components, or further distribute them. For example, some computing architectures may have a single combined CPU/GPU chip. Processing may be dual-core, quad-core, single chip, etc.

FIG. 2a illustrates an example of a schematic structure of a multi-tenant backend system with a shared userbase with both shared and non-shared users as well as various developers as tenants. In this particular example embodiment, the multi-tenant system contains three developers 2000, 2001, and 2002. In the example system, of course there may be more developers that sign on to the system. In this example also, each developer has two applications developed per developer. App 2010 and 2011 are developed by developer 2000; app 2012 and 2013 are developed by 2001; and app 2014 and 2015 are developed by developer 2002. Of course, in the example, we are simply designating that the apps are under the purview of the particular developer. It may be that a specific “developer” is a publisher, and therefore the app may be developed by another developer, but then the application information is managed by the publisher or other developer. Or, a developer may be a contractor and develop the app for another company or publisher, but the company or publisher may still want that developer to monitor the app for them. Therefore, the relationship between app and developer may not have to be purely that of the actual entity that developed the product; rather, an app may be administered or monitored by a different entity that is the tenant on the multi-tenant system.

App Data may be associated with the each application, for example, in the example embodiment there is app data 2040 for app 2010; app data 2041 for app 2011; app data 2042 for app 2012; app data 2043 for app 2013; app data 2044 for app 2014; and app data 2045 for app 2015. App data may consist of any sort of data saved per feature, such as user data or gameplay data. For example, user data that is related to an app may include a user's specific amount of virtual currency in the application, a user's unlocked items, an avatar specific to an application, gameplay records (i.e. win/loss records, leaderboard scores and rankings, ELO skill ratings, etc.). App data may also include elements specific to the application. For example, if the application were a game, app data may include gameplay data. Alternative embodiments may have data stored in different data structures. For example, “chat” data or conversations may be stored with the user data of the app data, but “chat” data may alternatively be stored with the gameplay data if a “chat” was associated with the gameplay data. For example, in an asynchronous game, there may be various matches between players. In an example embodiment, “chat” data may be associated with the matches between players. In other alternative embodiments, “chat” data may be associated between the players and not with particular matches, thus possibly stored with the user data.

The multi-tenant system may contain global users that are shared across applications or developers. Alternatively app users may be specific to an app or even specific to a developer. For example, global shared users 2030 may be used across several games so that users need only learn a single “login” (e.g. username, e-mail, password, or any unique combination per user thereof) to enter an app. On the other hand, a developer may choose not to participate in the global shared user-base and thus have an app 2013 that has app users 2031 which are completely separate from the global shared users 2030 of the multi-tenant system. In yet another alternative model, a developer 2002 may be a publisher and want all the app users 2032 to be shared among all the apps 2014 and 2015 published by the publisher, i.e. developer 2002. In addition, each developer may have its own custom business logic 2050 associated either with the developer, or as in the example shown, associated with the app 2015 or that can manipulate app data 2045 or app users 2032. To ensure the integrity of the global shared users 2030, the multi-tenant system may separate the data related to the global shared users 2030 from that of individual apps, though it may still allow individual apps that use the shared users to alter some of the global shared users' 2030 info.

FIG. 2b illustrates an example of a data structure relationship of a multi-tenant backend system with a shared userbase with both shared and non-shared users. The multi-tenant system may be implemented using any variety of database languages or database management systems, such as a relational database management system (RDBMS) or NoSQL database system, Structured Query Language (SQL), or any other variants or database paradigms. For example, a multi-tenant system may contain a multi-tenant database 2100. The database may contain various collections such as a global shared user 2101, App1 2110 or App2 2120. Each of the collections may vary in the amount of depth of information. For example, global shared user information may contain all the information for that user, as well as all the information for each of the apps that the user used in the multi-tenant system. Alternatively, the global shared user may contain an extremely shallow amount of information that is only the information shared by all the apps and have the app specific information stored within the documents of that particular app. The shared information may be, for example, login information or avatar information, or even identification information for the “friends” of the shared users within the multi-tenant system or even “opponents” of that user. Global Shared User 2101 information may also contain the associations with various social networks as each unique user may have a unique account with social networks (e.g. Facebook, Myspace, etc.), a social discovery network (e.g. Game Center, Game Circle), or publisher.

Within each app there may be a series of documents. For example, App1 2110 has the documents App1_User 2111, App1_Matches, 2112, App1_Items 2113, App1_Bundles, and App1_Currency 2113. Each document may store the information in any number of data formats or data structures. For example, the documents may score sub-document information in a JSON (JavaScript Object Notation) BLOB (binary large object). For example, if App1 2110 were an asynchronous game, the App1_Matches 2112 document may further store individual matches which contain information such as the App1_Moves 2114 and the App1_Chats 2115. Of course, an app developer may want chats to be associated between users and not specific to a match. In such a case, there may be a specific App1_Chats document instead.

In the FIG. 2b example, there may be an App2 2120 structured in an alternative way where the App2_User has information associated with those users that is also related to the application. For example, each user may have data structures that hold a user's leaderboard ranking and achievements held in a BLOB, such as App2_Leaderboards 2126 and App2_Achievements 2127. Alternatively, the data may be structured such that the one or more leaderboards for an app are consolidated into an ordered ranking within a document, rather than stored with the user information. If the example App2 2120 were a management game, rather than an async game, it may contain documents specific to that app, such as the App2_buildings 2122, App2_Items 2123, App2_Bundles 2124, and App2_Currency 2125. As the multi-tenant system is open to other networks, the leaderboard of the multi-tenant system may be mirrored in various other social networks or social discovery networks within specific platforms. However, the multi-tenant system would merge the data such that it is sorted and viewable by users across platforms.

In the example App2 2120, there may also be business logic stored as App2_Business_Logic 2130 that may be in the same database or in a completely different database or even server. Depending on the level of security needed, it may be important to separate the business logic, which may be run on a processor that can change the data app input from a client device before it reaches the databases of the App2 2120. Processing of the business logic may be performed wherein normal processing by the multi-tenant system is circumvented. Alternatively, the business logic may be enhancing the processing by accepting information from a client device that may not be in the format that the multi-tenant system may accept. The business logic may use a computing processor to alter the information and create a new packet of data in a format that is acceptable by the multi-tenant system or the logic of the specific app collections. In alternative embodiments, the business logic may simply be directly implemented on the servers of the multi-tenant system. The access level may be determined by factors such as security, wherein the multi-tenant system may not want third party servers or third party processors to alter the data stored on the multi-tenant system. On the other hand, multi-tenant systems may form partnerships with developers that may allow such processing to be done directly on the multi-tenant system.

Depending on the type of database, the information may be separated via collections, documents, and data structures, though the database may just as easily structured as a group of tables and rows that contains information. Alternatively, the multi-tenant system may be structured such that each app is its own database and a global shared user was stored in a separate database but accessible by each of the apps. The app should be able to access this global information so that the apps are able to share the users and also store preferences of the user, such as account settings regarding push notifications, sound settings, etc. In apps that do not involve interaction between users, the database may store user profile data with match information for the sake of simplicity.

How the database is conceptually arranged may not be how the data is physically stored. Any number of storage methods may be implemented based on any number of factors, such as scalability, latency, redundancy, memory usage, index size, physical location of the database, and other efficiency or cost factors. Methods, such as database sharding, may be applied to facilitate the implementation of the above data structure relationship.

FIG. 3a depicts an example process flow of how a multi-tenant system with shared users and non-shared users may receive and process data from a client. The client may first receive data from the client 3000, and through some type of session token, token id, or authorization using username/password the multi-tenant system may determine if the user is logged in 3001. If the user is not logged in, it may the user's first time as a user on the multi-tenant system. If the user has signed up, then the multi-tenant system may have to verify the password 3003 of the user. If the user has not signed up, the multi-tenant system determines if the app uses a shared user 3004. If the users are shared among an app, the user's signup credentials may be stored among the shared user signup 3006. The shared user may be global to the multi-tenant system or among the developer. However, if the app does not use a shared user, the user's signup credential s may be stored for that particular app's signup 3005.

If the user had been properly logged in 3001, the multi-tenant system would then determine if the information sent was for processing. It is possible that the data would first to check to send the data to Business Logic 3007. If any part of the data is needed to be first manipulated by business logic it would be sent for processing 3008. The business logic may alter the data and return the altered data, or business logic may simply trigger processing in another part of the multi-tenant system.

FIG. 3a describes an exemplary process flow, and business logic and the other processing steps may be performed in any order and may repeat various times in the multi-tenant system. In example FIG. 1b, the API Processing 1103 may determine when the third party logic module 1117 may be accessed, as well as which data the application module 1108 would receive. Therefore, the processing order may have different combinations of data that is sent through an application module and then possibly back for more third party logic processing.

If the data was not previously sent to business logic 3007 or even if it has been processed by business logic 3008, the multi-tenant system may need to further process the information when it receives the data 3009 sent from the original network. If the data is user data 3010 then the multi-tenant system will allow any processing or changes of the user data according to whether it is a global shared user 3011 among all developers and apps of the multi-tenant system, a users shared among the developers 3012, or otherwise it is simply altering the app's userbase 3015. An app that is using the global shared user would still have individual app specific user data; therefore, even if global user data is processed 3013, app user data 3015 may also be altered. Also, depending on how developers want to share their data, the developer may participate in all types of login, global, shared developer, and individual app data. Data may therefore be processed for global 3013, developer 3014 or app specific 3015 user data. Otherwise, if user data is not processed, the data may be for the app's data 3016.

FIG. 3b depicts an example process flow of how a multi-tenant system with shared users and non-shared users may receive and process non-user data from a client. The multi-tenant system may receive app data 3100, and this data may not be user data, such as if the data came from step 3016 of FIG. 3a. The multi-tenant system may receive data that needs to propagate through various features modules 3101. For example, there may be non-gameplay information such as the purchase of an inventory item using virtual currency. In the example, the multi-tenant system may process the feature 3102 by deducting currency from the virtual currency feature. If the user has devices or accounts across many platforms 3107, the result may need to be reflected across multiple platforms 3108. In many cases, the processing of the propagation across platforms 3108 is integrated within the processing of the features 3102. For example, if the data is simply related to currency, then data may simply be propagated cross-platform by virtue of it being stored or updated 3106 in the database, wherein another device requesting an update of the information may retrieve the altered data. On the other hand, if data is proactively pushed to a user, such as a chat message, the chat message may be stored 3106, but further processing 3109 may be needed to go through a have a push notification sent to each device of for the chat message to appear in both the sender's device as well as the receiver's device.

Similarly, in applications that involve gameplay where users in the application are frequently in contact with each other, more processing may be involved. For example, if data involved gameplay data with an opponent 3103, such as match or move info in an asynchronous game, gameplay information may be processed with the opponent 3104. The opponent's user data 3105 may also be retrieved. The move data may be stored 3106, but the move may also be pushed to a user across platforms 3107-3108. The opponent data previously retrieved 3105 may assist in propagating the move data across platforms 3108. If there is more data to process 3109 the system may go through the flow again starting from 3100. For example, if a powerup is purchased in the game, this may require of the inventory management system in addition to the virtual currency system. Therefore, both of these would need to be updated in the flow 3101, 3102, 3106, 3107, 3108, 3109 and back to 3100, and more if push notifications are required. However, the multi-tenant system may simply store and update the data that has been altered 3110 if there are no other modules or features affected by processed network call.

As with FIG. 3a, the order of processing may be done in different orders depending on the physical and virtual layout of the networking servers and databases. For example, some data may be propagated across platforms first and then saved. Other data may not be saved at all and must be processed on the feature side completely before any platform propagation occurs. Or, in other instance, gameplay data must be propagated before non-gameplay features are propagated. In addition, some data, such as virtual currency or inventory for an app may be considered as part of the user data, while other apps may consider such data to be purely associated and stored with the app data.

Part of the difficulties of handling the multi-tenant system is that some developers may create apps on the multi-tenant system wherein users are shared and gameplay and non-gameplay data may be affected. Developers may initially choose to have apps have a userbase closed to the app or closed within that particular developer's group of apps. However, some developers may also choose to upgrade from the closed individual app network to the global shared userbase of the multi-tenant system. One reason a developer may want to do this is because users tend to not even try using an app if they are presented with a signup. Also, many users frequently forget their logins or passwords. Therefore, if a user only has to remember a single login for a global network of the multi-tenant system, the user may be more likely to not only signup but also remember their login and password. However, before using the global shared userbase, the developer may want to test the gameplay and other features of the multi-tenant system before upgrading their userbase to share with the global userbase of the multi-tenant system. In addition, some developers may add applications that were already published to the public. The developers may want to upgrade their outside userbase into the multi-tenant global shared userbase.

Regardless of the method that a developer is upgrading their userbase, the developer will request the merger to the multi-tenant system 3300. The multi-tenant system must first determine where the applications came from 3301. For example, if the applications were not within the multi-tenant system, then a temporary mirror profile may be created 3302 because while each individual user in the app may be unique, they may actually be the same user within the multi-tenant system. On the other hand, if the developer had already created the app on the multi-tenant system and was upgrading from an app userbase to a broader developer or global shared userbase, the multi-tenant system would have already assigned those users a unique id 3303 within the multi-tenant system. In either case, each individual user would enter have a unique id, whether as part of a temporary profile 3302 or an already unique id within the system 3303. Any conflicts between the data would have to be reconciled initially. For example, if the multi-tenant system only allowed unique usernames across the system, then any repeated username that would've been unique to the upgrading app would have to be changed. A notification, such as an email or push notification, may be sent to each user that did not have a unique id asking them to change their username. Alternatively, in multi-tenant systems that did not have unique identification, a table may store all the unique id's corresponding to same usernames. Alternatively, the multi-tenant system may simply pre-assign them a new username and password, but keep the session id so that the user is still able to auto-sign onto the app but are prompted that they have a new username and password at that time.

Some of the userbase of the developers may have multiple layers of connections that would need to be de-coupled. For example, a user may be on a global shared userbase of the multi-tenant system with the username “fox” and on an app closed userbase with the username “tiger”. In both instances, the user signed on with the same social network identity. For both userbases, there would be a connection between the username and that same social network identity. If the multi-tenant system determined that there was a social network identity tied to the accounts 3305, the system would decouple the social network identity 3306. For example, the developer may have the option to choose to keep the user's username on its app and decouple the social network from the user app. Thus, the social network identity may be coupled to “fox” and “tiger.” Alternatively, the multi-tenant system may not allow any duplicate social network identities shared with usernames. In such an example, the multi-tenant's username of “fox” may be still tied to the social network identity and “tiger” as a username would be thrown away. However, the social network identity would be decoupled from “tiger” but still matched with the user's data on the app in order for that data to be later merged with the user data on the global shared userbase. If no social networks are involved 3305, then the app data is simpler filtered and merged 3307.

Filtering the shared data 3307 may vary depending on how the application is structured in addition to how the multi-tenant data is stored. For example, if the global shared userbase contains only account information, the unique id's would be tied to the global shared user and the app data would still be stored separately. However, if the in an alternative scheme, the app data is stored with user data, the app user data for the global shared user would have to allocate space for the app data. Thereafter, any redundancies 3308 between the mergers may be deleted or possibly archived in case the developer changed its mind and wanted to split the userbases back to its original form.

If a developer wanted to split the userbases to its original form or if the developer started on a broader developer or global shared userbase and wanted to silo an app to have its own userbase, the developer would have reverse the process. The developer would initiate a decouple userbase 3309 request. The multi-tenant system would identify the users in the global shared userbase that are currently using the app that is targeting a split. The userbase would be replicated 3310 for that app. If the user had any social network ties 3305 the developer may choose whether or not to keep those ties. If the developer chose to keep the ties, then the app data would simply be matched with the user info 3307; otherwise, the social network connections may be decoupled 3306. Finally, any redundancies are removed 3308 before the data is sequestered from the main global shared userbase.

Several example embodiments of the present invention are specifically illustrated and described herein. The advantages and features of the application are of a representative sample of embodiments only, and are not exhaustive and/or exclusive. They are presented only to assist in understanding and teaching the claimed principles. It should be understood that they are not representative of all claimed inventions. Moreover, they are not to be limited to the technologies or devices described herein. That an alternate embodiment may not have been presented is not a disclaimer of such alternate embodiment. It will be appreciated and understood that other embodiments may be utilized and functional, logical, organizational, structural and/or topological modifications may be made without departing from the scope and/or sprit of the embodiments discussed herein relative to those not discussed herein other than it is for purposes of non-repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others.

In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of an individual, entity, and/or enterprise user, database configuration and/or relational model, data type, data transmission and/or network framework, syntax structure, and/or the like, various embodiments of the invention, may be implemented that enable a great deal of flexibility and customization. For example, aspects of the invention may be adapted for non-game use. While various embodiments and discussions of the invention have been directed to examples in virtual games, however, it is to be understood that the embodiments described herein may be readily configured and/or customized for a wide variety of other applications and/or implementations.

What is claimed is:

1. A method for distributing data among a multi-tenant service containing a shared userbase, comprising:
receiving a first request to process a first data packet of data;
receiving a first key associated with the first data packet and a first application;
receiving a second key associated with the first data packet;
storing the data packet in a first storage location;
receiving a second request to obtain the data packet from the first storage location;
transmitting the first data packet in response to the second request; and
wherein each of the operations are executed by one or more processors.

2. The method for distributing data among a multi-tenant service containing a shared userbase, according to claim 1, wherein the second key is associated with a first user; and further comprising determining the first storage location within a first data module for the first data packet based on at least one of the first key, the second key, a user data type for the first data packet, wherein user data type is one of shared or non-shared.

3. The method for distributing data among a multi-tenant service containing a shared userbase, according to claim 1, wherein the first data packet is one of gameplay or non-gameplay data.

4. The method for distributing data among a multi-tenant service containing a shared userbase, according to claim 1, wherein the first data packet comprises at least one of leaderboard ranking, leaderboard score, leaderboard rating, non-leaderboard related skill rating, achievement, state data, gameplay data, virtual currency balance, inventory balance, and avatar selection.

5. The method for distributing data among a multi-tenant service containing a shared userbase, according to claim 1, further comprising:
receiving business logic instructions; and
executing the business logic instructions on the first data packet.

6. The method for distributing data among a multi-tenant service containing a shared userbase, according to claim 1, further comprising
sending the first data packet to be processed; and
receiving the processed first data packet and further storing the first data packet.

7. The method for distributing data among a multi-tenant service containing a shared userbase, according to claim 1, further comprising triggering the transmission of a network call to a third party.

8. The method for distributing data among a multi-tenant service containing a shared userbase, according to claim 7, wherein the third party is a push notification server and the user notified is shared on the multi-tenant system.

9. An apparatus, comprising: one or more processors; and a memory coupled to the processors comprising instructions executable by the processors, the processors operable when executing the instructions to:
receive a first request to process a first data packet of data;
receive a first key associated with the first data packet and a first application;
receive a second key associated with the first data packet;
store the data packet in a first storage location;
receive a second request to obtain the data packet from the first storage location; and
transmit the first data packet in response to the second request.

10. The apparatus of claim 9, further comprising executing instructions, wherein the second key is associated with a first user; and further comprising determining the first storage location within a first data module for the first data packet based on at least one of the first key, the second key, a user data type for the first data packet, wherein user data type is one of shared or non-shared.

11. The apparatus of claim 9, further comprising executing instructions, wherein the first data packet is one of gameplay or non-gameplay data.

12. The apparatus of claim 9, further comprising executing instructions, wherein the first data packet comprises at least one of leaderboard ranking, leaderboard score, leaderboard rating, non-leaderboard related skill rating, achievement, state data, gameplay data, virtual currency balance, inventory balance, and avatar selection.

13. The apparatus of claim 9, further comprising executing instructions to:
receive business logic instructions; and
execute the business logic instructions on the first data packet.

14. The apparatus of claim 9, further comprising executing instructions to trigger the transmission of a network call to a third party.

15. A non-transitory, computer readable medium comprising instructions operative, when executed, cause one or more processors to perform operations comprising:
receiving a first request to process a first data packet of data;
receiving a first key associated with the first data packet and a first application;
receiving a second key associated with the first data packet;
storing the data packet in a first storage location;
receiving a second request to obtain the data packet from the first storage location;
transmitting the first data packet in response to the second request; and
wherein each of the operations are executed by one or more processors.

16. The non-transitory, computer readable medium of claim 15, comprising instructions operative, when executed, to cause one or more processors to perform operations, wherein the second key is associated with a first user; and further comprising determining the first storage location within a first data module for the first data packet based on at least one of the first key, the second key, a user data type for the first data packet, wherein user data type is one of shared or non-shared.

17. The non-transitory, computer readable medium of claim 15, comprising instructions operative, when executed, to cause one or more processors to perform operations, wherein the first data packet is one of gameplay or non-gameplay data.

18. The non-transitory, computer readable medium of claim 15, comprising instructions operative, when executed, to cause one or more processors to perform operations, wherein the first data packet comprises at least one of leaderboard ranking, leaderboard score, leaderboard rating, non-leaderboard related skill rating, achievement, state data, gameplay data, virtual currency balance, inventory balance, and avatar selection.

19. The non-transitory, computer readable medium of claim 15, comprising instructions operative, when executed, to cause one or more processors to perform operations, further comprising:
receiving business logic instructions; and
executing the business logic instructions on the first data packet.

20. The non-transitory, computer readable medium of claim 15, comprising instructions operative, when executed, to trigger the transmission of a network call to a third party.
